(19) United States
(12) Patent Application Publication
(10) Pub. No.: US 2006/0146431 A1
(43) Pub. Date: Jul. 6, 2006

(54) Information recording device, information recording method, and recording medium region management method

(76) Inventors: Masaharu Tsujimura, Toyonaka-shi (JP); Tohru Hori, Ikoma-shi (JP); Kenichi Kunimitsu, Osaka-shi (JP)

Correspondence Address: WENDEROTH, LIND & PONACK L.L.P., 2033 K. STREET, NW, SUITE 800, WASHINGTON, DC, 20006, US

(21) Appl. No.: 10/543,922

(22) PCT Filed: Jan. 29, 2004
(86) PCT No.: PCT/JP04/00822

§ 371 Date: Mar. 7, 2006

(30) Foreign Application Priority Data
Jan. 31, 2003 (JP) 2003-023771

(51) Int. Cl. G11B 27/36; G06F 11/00

(52) U.S. Cl. 360/31; 714/42

(57) ABSTRACT

An information recording apparatus of the present invention writes input data on a recording medium by the predetermined data amount, and each time the writing of data of the predetermined data amount is completed, reads the data from the area on the recording medium on which the data is written just before and measures a time required for the reading (S15), and compares the measured read time with a predetermined limit time (S16). If the measured time exceeds the limit time, the area on the recording medium from which the reading is performed is determined to be a defective area (S17). Subsequently the area determined to be defective is replaced with another normal area on the recording medium. In this way, an area with a long read time is replaced with another area where reading can be performed normally, thereby the real-time property is ensured in the reproducing operation.

### TECHNICAL FIELD

The present invention relates to an apparatus for recording and reproducing data to and from a recording medium such as an optical disk, a magneto-optic disk, a magnetic disk and a hard disk, in particular to the apparatus capable of recording and reproducing data requiring real-time processing such as video data.

### BACKGROUND ART

As information recording apparatuses for recording and reproducing a large amount of AV data such as video and audio, magnetic disk devices are typical. Among them, hard disk devices are increasingly applied to digital AV equipment rapidly in recent years, since the devices have such advantages as large capacity and high-speed accessibility (see, for example, Patent Document 1 shown below).

When continuous data such as AV data is handled by using a hard disk device, it is important to assure the continuity of accessing to the hard disk such that the video and audio are not interrupted when being recorded or reproduced. However, since a hard disk device has been developed as an auxiliary storage device for a computer, it does not assure that recording and reproducing operations are to be completed within a certain period of time (real-time property), although it exhibits excellent performance in reading and writing data with high reliability.

In order to secure data continuity at a time of actual operation, a method of providing a buffer memory which stores data temporarily is also used. However, it is required to enlarge the memory size substantially for assuring the real-time property completely, resulting in a cost increase.

As a recording method enabling a real-time operation to a disk, there is one disclosed in Patent Document 2. In the method disclosed in Patent Document 2, a time period required for a writing operation of data is measured when the data is written, and when the write time exceeds a predetermined time period, an area on which the writing has been performed is determined as a defective area, and an replacing process for assigning the defective area to another normal area (replacement area) is performed. Thereby, the data continuity at the time of real operation is assured.

Patent Document 1: JP, 2000-76793, A

Patent Document 2: JP, 2003-196924, A

### DISCLOSURE OF THE INVENTION

### PROBLEMS TO BE SOLVED BY THE INVENTION

In order to ensure continuity of data in real operation, it is considered to prevent reading and writing of data to an area where real-time property cannot be ensured. In this case, however, there is a problem that how the area is specified. In Patent Document 2, the area is specified based on the write time when recording.

In reproducing, the read time may be changed depending on conditions when recording, that is, a head position of the hard disk or the voltage level of the write signal, for example. Accordingly, there may be a case where reading cannot be performed within a certain allowable read time, although writing could be performed within a certain allowable write time. That is, even though the real-time property is secured when writing, the real-time property when reading is not secured. In the method of Patent Document 2, there is a problem that the real-time property is not ensured reliably in such a case.

(Solving Means)

An information recording apparatus according to the invention is an information recording apparatus capable of recording input data and reproducing recorded information. The apparatus includes an input unit that inputs data from outside, a recording medium that recording the input data, and a controller that controls recording and reproducing of data to/from the recording medium. During a recording operation for recording the input data on the recording medium by a predetermined amount of data, each time writing of the predetermined amount of data is completed, the controller reads data from an area of the recording medium in which the data is written just before, and measures a time required for the reading. The controller compares the measured time for the reading with a predetermined limit time, and determines that the area on the recording medium from which the reading is performed to be a defective area if the measured time exceeds the limit time. Subsequently, the controller may perform an replacing process to replace the area determined to be a defective area with another normal area on the recording medium.

The controller may also verify whether the area determined to be a defective area is really a defective area by performing reading and writing operations of data to the area for a predetermined number of times, and based on a verification result, determines whether the area determined to be a defective area should be replaced with another normal area on the recording medium.

The information recording apparatus may further include error list information that registers the area determined to be a defective area. In this case, the controller preferably performs the replacing process for a plurality of areas registered in the error list information in descending order of measured read time.

The information may further include a buffer memory that stores data temporarily when recording the data onto the recording medium or reproducing the data from the recording medium. In this case, the controller may change the lit time based on the free space size of the buffer memory.

An area management method of a recording medium according to the invention is a method for replacing a defective area with another normal area in the recording medium capable of recording and reproducing data. In the area management, while data is read from the recording medium, a time required for the reading is measured. The measured reading time is compared with a predetermined limit time. It is determined that an area on the recording medium from which the reading is performed to be a defective area if the measured time exceeds the limit time. Subsequently, the area determined to be the defective area may be replaced with another normal area on the recording medium.

An information recording method according to the invention is a method for recording input data on a recording medium. In the method, input data is written on the recording medium by a predetermined amount of data. Each time the writing of the predetermined amount of data is completed, the data is read from an area on the recording medium to which the data is written just before, and a time required for the reading is measured. The measured reading time is compared with a predetermined limit time, and when the measured reading time exceeds the limit time, it is determined the area on the recording medium from which the reading is performed to be a defective area. Subsequently, the area determined to be a defective area may be replaced with another normal area.

An information recording apparatus according to the invention is an apparatus for recording input data on a recording medium. The apparatus includes input unit that inputs data from external, a recording medium that records the input data, a buffer that stores data temporally during write and read operations, a controller that controls write and read operations to the recording medium. During write and read operations, the controller monitors free space of the buffer, determines necessity of saving system data based on the free space of the buffer, and stores the system data to the recording medium when it is determined that saving system data is necessary.

### EFFECTS OF THE INVENTION

According to the present invention, an area on the recording medium where data read time exceeds the predetermined time is replaced with another normal area on the recording medium. Thereby, it is possible to read data within a predetermined time period securely in reproducing operation, and also to ensure the real-time property in reproducing operation securely.

### BRIEF DESCRIPTION OF DRAWINGS

FIG. 1 is a diagram showing a configuration of an information recording apparatus according to the present invention.

FIG. 2A is a diagram for explaining an overview of a recording operation via a buffer memory.

FIG. 2B is a diagram for explaining the overview of a reproducing operation via a buffer memory.

FIG. 3A is a flowchart of an operation during a recording operation of the information recording apparatus.

FIG. 3B is a diagram for explaining an replacing process on a hard disk.

FIG. 4 is a flowchart showing a recording process in the flowchart during recording operation (first embodiment).

FIG. 5A is a diagram explaining a conversion table before an replacing process, and FIG. 5B is a diagram explaining the conversion table after the replacing process.

FIG. 6A is a diagram explaining an error registration list before a sorting process, and FIG. 6B is a diagram showing the error registration list after the sorting process.

FIG. 7 is a flowchart showing an replacing process in the flowchart during the recording operation.

FIG. 8 is a flowchart showing a verification process in the flowchart of the replacing process.

FIG. 9 is a flowchart of an operation during a reproducing operation of the information recording apparatus.

FIG. 10 is a flowchart showing a reproducing process in the flowchart during the reproducing operation.

FIG. 11 is a flowchart showing a recording process in the flowchart during the recording operation (second embodiment).

### BEST MODE FOR CARRYING OUT THE INVENTION

Hereinafter, embodiments of an information recording apparatus, an information recording method, and an area management method for a recording medium according to the present invention will be explained with reference to the accompanying drawings.

### First Embodiment

1. Configuration of Information Recording Apparatus

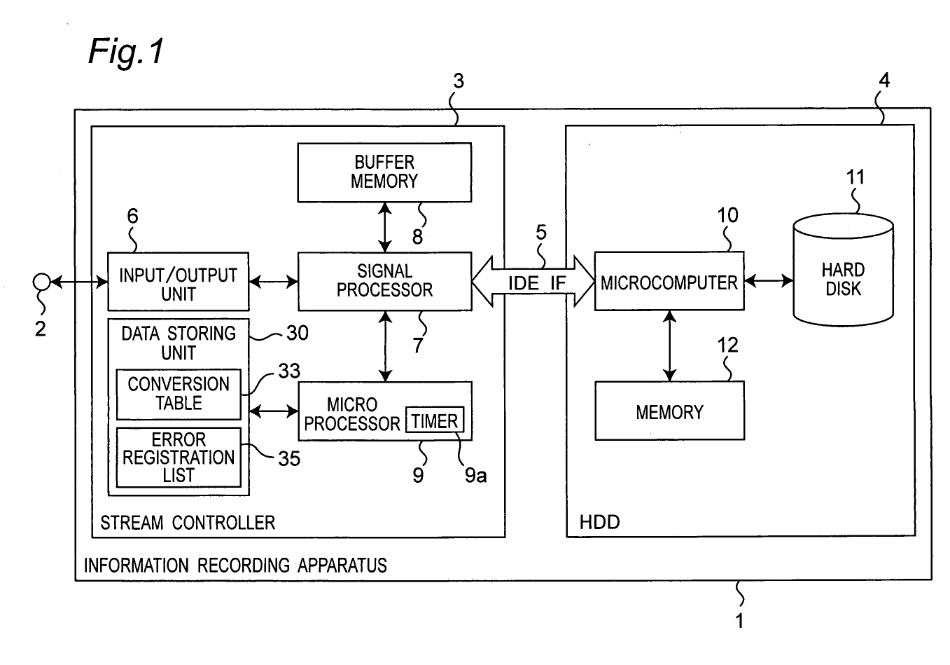

FIG. 1 shows an exemplary configuration of an information recording apparatus according to the present invention. An information recording apparatus 1 includes a stream controller 3 for controlling predetermined signal processing and record and reproduction processing those performed to information input via an IEEE1394 interface 2, and a hard disk device 4 for storing information after signal processing. Data is exchanged between the stream controller 3 and the hard disk device 4 via an IDE interface 5.

The information recording apparatus 1 which is connected to an external device such as a tuner for digital broadcasting via the IEEE1394 interface 2, receives from the outside device an MPEG2 transport stream and digital video and audio signals conforming to a standard such as MPEG4 used for satellite digital broadcasting or terrestrial digital broadcasting, and records them on the hard disk device 4. Further, recording and reproducing operations of the information recording apparatus 1 are controllable by user operations or by commands from the external device.

The stream controller 3 is composed of an input/output unit 6, a signal processor 7, a buffer memory 8, a microprocessor (record control unit) 9, and a data storing unit 30. The input/output unit 6 exchanges commands and AV data with the external device via the IEEE1394 interface 2. The buffer memory 8 includes an SDRAM (synchronous dynamic RAM) storing data temporarily, but it may be any kind of a memory which is random accessible.

During recording operation, the signal processor 7 prepares information for internal management and adds it to an input digital video signal such as MPEG2 transport stream to thereby convert the input video signal to a record signal suitable for recording. The converted record signal is stored temporarily in the buffer memory 8 by the signal processor 7. Further, during reproducing operation, the signal processor 7 removes the information for internal management from the signal read out of the hard disk device 4, to convert the read signal to a signal in the same signal format as that at the time of inputting.

The microprocessor 9 is a means for controlling operations of the input/output unit 6 and the signal processor 7. The buffer memory 8 consists of memories for recording and reproducing, respectively, and as the capacity is larger, the real-time property is easily assured, but the cost increases. The microprocessor 9 is provided with an internal timer 9a, and is capable of measuring a write time and a read time.

The hard disk device 4 includes a microcomputer 10 for controlling operations of the hard disk device 4, a hard disk 11 which is a nonvolatile recording medium, and a cache memory 12. The microcomputer 10 controls the hard disk 11 so as to control exchanging commands and recording and reproducing to/from the hard disk 11. The cache memory 12 is a means for storing information to realize recording and reproducing to/from the hard disk 11 effectively.

Note that another nonvolatile recording medium may be used instead of the hard disk device 4. Further, the IEEE1394 interface 2 and the IDE interface 5 may be substituted with interfaces of other standards.

In the present embodiment, the microprocessor 9 and the microcomputer 10 realize functions explained in the present embodiment by executing predetermined control programs. Such control programs are stored on a recording medium such as the hard disk 11, a read only memory (ROM) incorporated in the microprocessor 9, a flash memory, or a CD-ROM and the microprocessor 9. Those are read out from time to time to be executed.

2. Operation of Information Recording Apparatus

The operation of the information recording apparatus configured as described above will be explained.

First, an overview of recording and reproducing operations via the buffer memory 8 by the information recording apparatus 1 of the present embodiment will be explained.

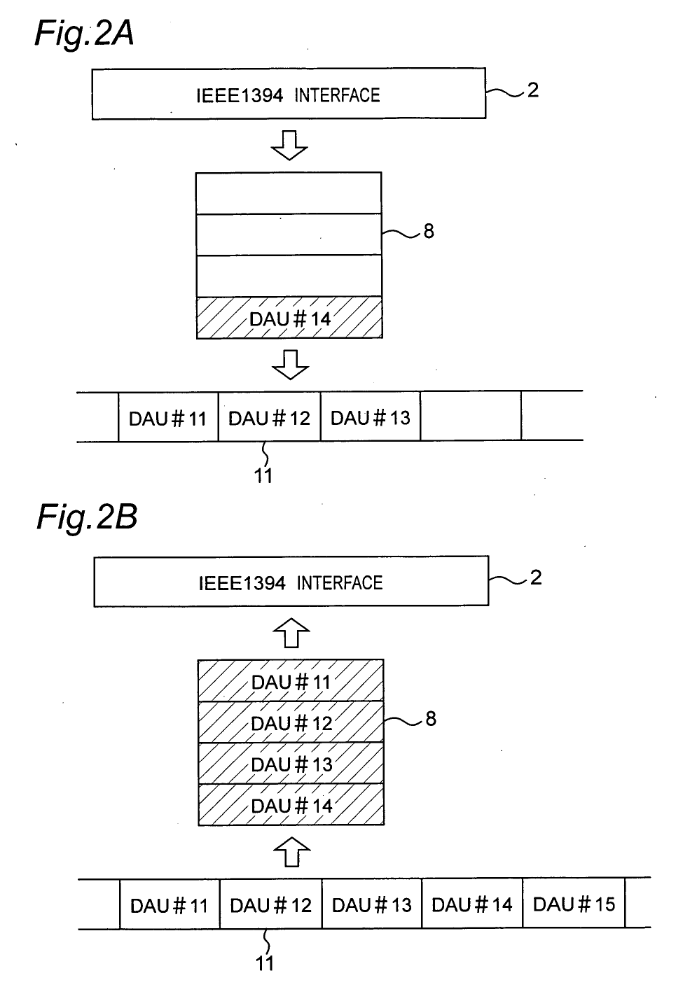

As shown in FIG. 2A, during recording operation, data input via the IEEE1394 interface 2 is stored on the buffer memory 8 temporarily, and is written on the hard disk 11 by a predetermined data unit (minimum data unit continuously written on the hard disk device 4, hereinafter referred to as DAU (Disk Access Unit)). Similarly, as shown in FIG. 2B, during reproducing operation, the data is read out from the hard disk 11 by the DAU, and is stored on the buffer memory 8 temporarily, and then is output to the IEEE1394 interface 2. Note that the size of a DAU can be optimized according to the transfer rate and the size of the buffer memory.

As described above, the information recording apparatus 1 of the present embodiment writes and reads data to/from the hard disk 11 by the DAU. Therefore, for writing one unit of data (e.g., data of one program), the information recording apparatus 1 divides the data into plural pieces of data of a size corresponding to the DAU size, and writes each divided piece of data while corresponding each piece with a DAU. Therefore, the information recording apparatus 1 corresponds the original data to the respective plural DAUs constituting the original data, and retains the corresponding information as a table. That is, regarding the data held by the recording apparatus 1, the information recording apparatus 1 has information showing DAUs which are used for the data,. Further, the information recording apparatus 1 has a table (hereinafter referred to as “conversion table”) in which each DAU and a logical position (head LBA) on the hard disk where a piece of data of the DAU is stored are corresponded. As shown in FIG. 1, a conversion table 33 is stored on the data storing unit 30.

More specifically, during recording operation, when data of one DAU is accumulated on the buffer memory 8, the microprocessor 9 issues a write command, while designating the head LBA (logical block address) of the DAU to be written on the hard disk device 4 and the number of transfer sectors corresponding to the data size to be written. Upon receipt of it, the hard disk device 4 performs data writing to the hard disk 11.

During reproducing operation, the microprocessor 9 issues a read command while designating the head LBA of the DAU to be read out of the hard disk device 4 and the number of transfer sectors. The read data is stored on the buffer memory 8 temporarily. As for the data stored on the buffer memory 8, information for internal management is deleted by the signal processor 7, and the data is converted to be in a signal format same as that at the time of inputting, and then output from the input/output unit 6.

2.1 Data Recording Operation

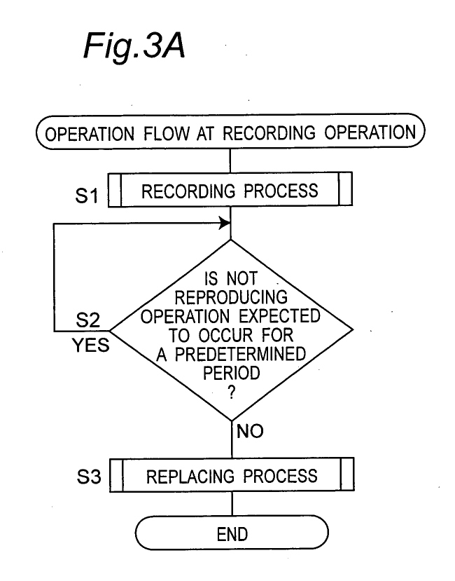

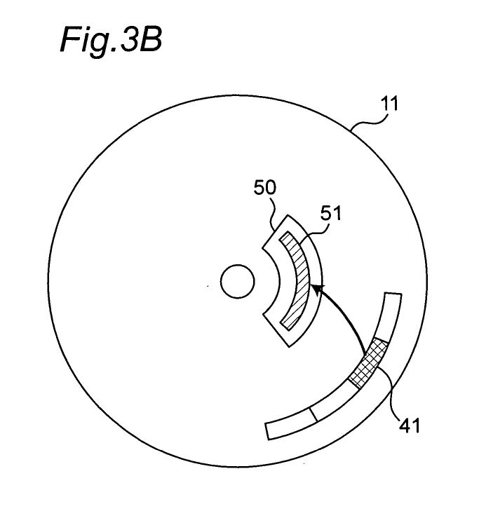

The operation during data recording of the information recording apparatus of the present embodiment will be explained by using FIG. 3A.

When a video signal is input via the IEEE1394 interface 2, the information recording apparatus 1 performs predetermined processing, and then records information sequentially onto the hard disk 11. At this time, the microprocessor 9 measures a data read time in a verification process after the data recording. If the read time exceeds the predetermined limit time, the microprocessor 9 determines the area to be a defective area, and registers information about the area in an error registration list. The error registration list is stored on the data storing unit 30 as shown in FIG. 1.

After the recording process (S1) is completed, if it is expected that the reproducing operation will not occur within a certain period of time (No in S2), replacing process is executed (S3). Here, the case that the reproducing operation will not occur within a certain period includes a case that the power switch of the information recording apparatus 1 is turned off, for example. In this case, it is considered that the user turned off the power switch since the user was not going to use for some time, so it is expected that a reproducing operation will not be instructed for a certain period of time. Alternatively, if an operating instruction has not been given for a certain period of time (e.g., for several tens of seconds) after the recording process, it may be expected that a reproducing operation will not occur within a certain period of time. In other words, replacing process is executed when it is determined that there is sufficient time for performing the replacing process.

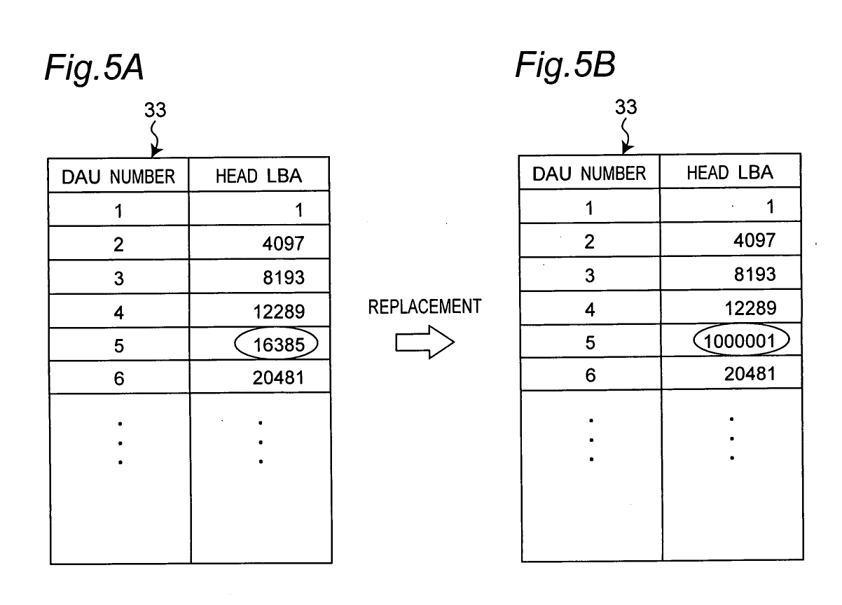

The replacing process will be described. In the replacing process, the defective area registered in the error registration list 35 is substituted with a normal area (area where the read time is within the allowable range) is performed. As shown in FIG. 3B, in the hard disk device 4 in general, there is prepared an replace area 50 with which a defective area is replaced when the defective area incapable of performing read or write normally on the hard disk 11 is found. In replacing process, if an area 41 is a defective area, data to be written on the area 41 is written on an area 51 in the replace area 50, and the conversion table is rewritten such that the area 51 in the replace area 50 is used as a substitute for the defective area 41 since then. For example, in a case where the defective area 41 corresponds to the fifth DAU, the head LBA is “16385”, and the head LBA of the area 51 is “1000001” in replacing process, the conversion table 33 is rewritten such that the state of the fifth DAU is changed from the state shown in FIG. 5A to that shown in FIG. 5B. Thereby, the area 51 corresponds to the fifth DAU since then, so an access to the defective area 41 is prevented.

The recording process (S1) and the replacing process (S3) will be explained in detail below.

2.1.1 Recording Process

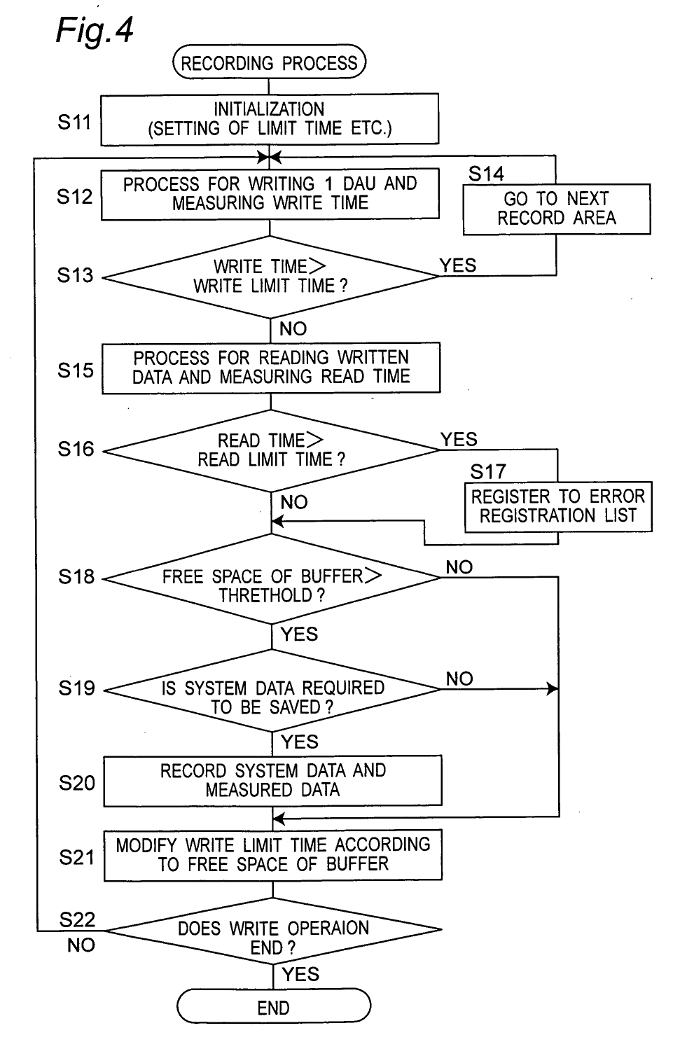

The recording process (step S1) will be explained by using FIG. 4.

First, setting of initial settings including a variable required in the following recording process, and initial settings including initialization of the internal timer 9a is carried out (S11). For example, a limit time (e.g., 150 ms) for each of the write processing and the read processing is set.

Next, the signal processor 7 writes AV data obtained by performing predetermined signal processing to the inputted video signal onto the hard disk 11 of the hard disk device 4 by one DAU, while measuring the time period required for the writing (S12). More specifically, the signal processor 5 transmits a write command specifying a write destination (head LBA) to which data is written and the data size, to the microcomputer 10 via the IDE interface 5. The write destination is obtained by referring to the conversion table 33. After transmitting the write command, the signal processor 7 transmits the AV data stored on the buffer memory 8 to the hard disk device 4 via the IDE interface 5. The microcomputer 10 of the hard disk device 4 writes the received AV data onto the hard disk 11. Upon completion of the writing operation, the microcomputer 10 transmits a response indicating the completion to the signal processor 7. The signal processor 7 transmits the received response to the microprocessor 9. The microprocessor 9 measures a time or period from the time of issuing the write command to the time of receiving from the hard disk device 4 the response indicating the completion of the writing as a “write time”, by using the internal timer 9a.

The microprocessor 9 compares the measured write time with the write limit time (S13). If the measured write time exceeds the write limit time, the microprocessor 9 determines that the area, on the hard disk 11, on which the data is written as a defective area, and gives up writing onto the area and skips to the next record area (next DAU) on the hard disk 11 (S14), and writes the same AV data thereon. For example, when writing data on the nth DAU, if the measured write time exceeds the write limit time, the data is written on the (n+1)th DAU. At this time, positioning information of a destination for skip is stored in the system data.

If the measured write time does not exceed the write limit time, data is read from the area on which writing has been performed just before, and a time required for the reading is measured (S15). The signal processor 7 reads AV data written on the hard disk device 4 just before from the hard disk device 4. The signal processor 7 issues a read command to the hard disk device 4 in which the read area is designated. The designation of the read area is performed by designating the head LBA by referring to the conversion table 33 stored on the data storing unit 30 as shown in FIG. 5A. The microcomputer 10 of the hard disk device 4 reads the AV data out of the hard disk 11 in accordance with the read command, and transmits the data to the signal processor 7. The microprocessor 9 measures a time required for the read processing. Specifically, the microprocessor 9 uses the internal timer 9a to measure a time or period from the time of issuing the read command to the time of receiving from the hard disk device 4 a response indicating the completion of the reading as a “read time”.

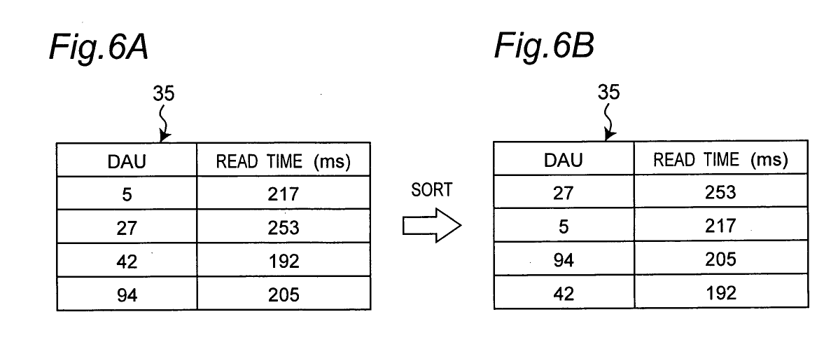

The microprocessor 9 compares the measured read time with the read limit time (S16). If the measured read time exceeds the read limit time, the microprocessor 9 registers the record area from which the reading was performed in the error registration list 35 (S17). That is, if the measured read time is longer than the read limit time, it is determined that the area from which the reading was performed may require a long time period for reading in a subsequent reproducing operation and that the area is a defective area which may cause a buffer underrun. Therefore, in order to transfer the data written on such a defective area to a normal area thereafter, information about the record area with long read time is added to the error registration list 35. FIG. 6A shows an example of the error registration list 35. As shown in FIG. 6A, number of DAU determined as defective and a read time of the DAU are corresponded with each other and registered in the error registration list 35.

During measurement of a write time or a read time, if the measured value exceeds the predetermined limit time, the microcomputer outputs a reset command to the hard disk device 4 so as to interrupt writing or reading operation. Upon receipt of the reset command, the hard disk device 4 interrupts the writing or reading operation and performs predetermined processing (reset processing). In this case, the measured time is a value which is the sum of the limit time and a time period required for the reset processing.

Then, it is determined whether free space size of the buffer memory 8 is larger than the predetermined threshold (S18). Note that the microprocessor 9 monitors the free space size of the buffer memory 8 during a recording operation.

Next, if the free space size of the buffer memory 8 is larger than the predetermined threshold, the microprocessor 9 determines whether system data is required to be saved (S19). Here, it is judged whether predetermined conditions (for example, constant interval), for determining whether to save the system data, are satisfied.

That is, if the free space size of the buffer memory 8 is larger than the threshold and other judgment conditions are satisfied, the microprocessor 9 determines that the system data is required to be saved, whereby it is controlled that the system data including information to be updated such as information held by the system is recorded in the hard disk device 4 (S20). At that time, information about the free space size is also stored in the hard disk device 4.

When the free space size of the buffer memory 8 is large, an overflow will not be caused even if AV data input via the IEEE1394 interface 2 is not immediately written on the hard disk device 4. Thus it is possible to accumulate the input AV data on the buffer memory 8, and therefore the real-time property is not inhibited even though the system data is written on the hard disk device 4. As described above, it is possible to perform an operation for storing data for which the real-time property is not required such as system data on the hard disk device 4 by selecting a timing when the buffer memory 8 has a sufficient free space. Therefore the real-time property at the time of writing AV data on the hard disk device 4 can be maintained. Note that the system data includes management information about record area (FAT, etc.) and program management information. In general, system data is saved on the hard disk device 4, and is read out by the buffer memory 8 when a power of the information recording apparatus is turned on, and is saved on the hard disk device 4 at a required timing when, for example, an operation is completed or the power is turned off.

In contrast, if the free space size of the buffer memory 8 is not larger than the threshold, an operation to write AV data on the hard disk device 4 is given preference so as to prevent the buffer memory 8 from overflowing. Therefore, system data is not saved.

Next, the microprocessor 9 changes the write limit time in accordance with the free space size of the buffer memory 8 (S21). For example, if the free space size of the buffer memory 8 is large, the write limit time is set to be longer. In the case of writing operation, if the free space size of the buffer memory 8 is large, the buffer memory 8 will not overflow even if writing to the hard disk 11 takes time, so there is no problem in extending the limit time. By modifying the limit time in accordance with the free space size of the buffer memory 8, it is possible to realize a writing operation control in a real time corresponding to the variations in the bit rate of information, whereby the buffer memory 8 can be used effectively.

Then, the microprocessor 9 determines whether writing of every AV data instructed from the user is completed (S22). When the microprocessor 9 determines that the writing is completed, or when the user instructs to stop recording of the AV data, the signal processing unit 7 ends writing of the AV data onto the hard disk device 4.

As described above, in the recording operation, the information recording apparatus of the present embodiment reads data from the area on which the data has been written after the writing of the data by the predetermined data unit. If the time required for the reading exceeds the limit time, the information recording apparatus determines the area to be a defective area, and registers the area in the error registration list 35. Then, by referring to the error registration list 35, an replacing process for replacing the area registered in the list 35 with another normal area on the hard disk 11 is performed.

In particular, in the present embodiment, an area is determined whether it is a defective area or not based on the time required for reading data from the area. Even when the write time is within the normal range when writing data on an area, it may take longer for reading the data from the area. In such a case, the continuity in the reproducing operation may not be secured. By determining a defective area based on the read time and performing an replacing process like the present embodiment, it is possible to surely prevent a buffer underrun at the time of, reproducing operation, so that the continuity in the reproducing operation can be secured reliably.

2.1.2 Replacing Process

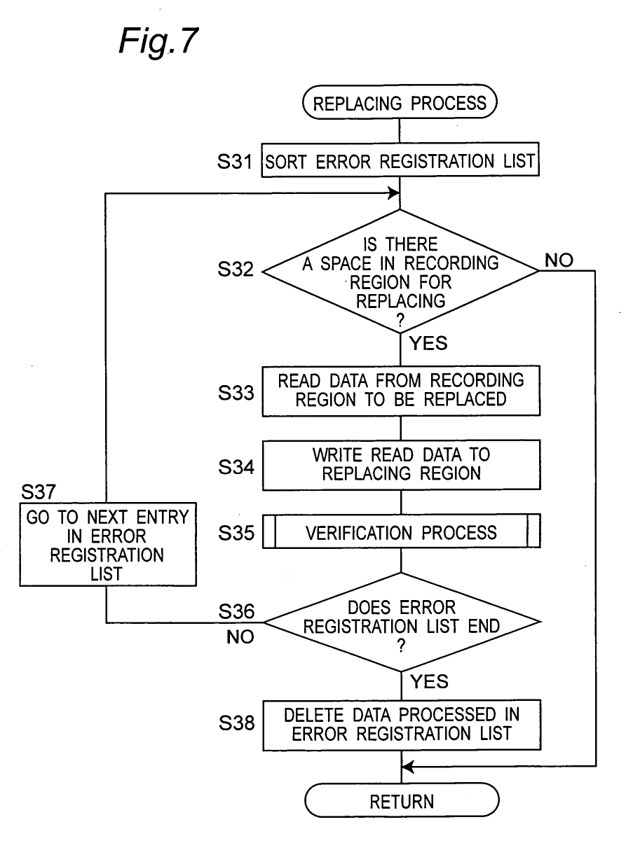

The replacing process (step S3) will be described by using FIG. 7.

First, the microprocessor 9 reads the error registration list 35 stored in the data storing unit 30, and sorting it in the descending order of the read time (S31). FIG. 6A shows the error registration list 35 before sorting, and FIG. 6B shows the error registration list 35 after sorting. Then, the microprocessor 9 performs an replacing process in sequence, starting from a DAU shown in the upper level in the list 35 after sorting. Thereby, a DAU of the longer read time is given priority for the replacing process, so it is possible to secure the real-time property effectively in reproducing the AV data. In the below-described explanation, the replacing process is performed for all areas registered in the error registration list 35. However, the replacing process may be performed for only the predetermined number of areas from the upper level. Further, when a predetermined interrupt signal is input during the replacing process, the replacing process may be suspended at that time.

Next, the microprocessor 9 detects a recording state of the replace area prepared on the hard disk 11, and determines if there is a space in the replace area for recording the data in the defective area (S32). For example, the microprocessor 9 determines if there is a free space, in the replace area on the hard disk 11, for recording the AV data of the 27th DAU registered in the error registration list shown in FIG. 6B.

If there is a free space on the hard disk 11, the signal processor 7 reads the AV data of the DAU registered in the error registration list 35 (S33). The signal processor 7 stores the read-out AV data in the buffer memory 8.

Next, the signal processor 7 writes the AV data stored on the buffer memory 8 onto the replace area on the hard disk 11 (S34). That is, the signal processor 7 outputs the AV data stored on the buffer memory 8 to the hard disk device 4, and the hard disk device 4 writes the AV data onto the replace area.

Next, the area, on the hard disk 11, of the DAU registered in the error registration list 35 is verified whether it is really a defective area requiring a long read time (S35). This verification is performed by repeating reading and writing processes for a certain number of times (e.g., 30 times). If the area is verified that it is really a defective area through the verification process, the content of the conversion table 33 (head LBA of the area to be replaced) is rewritten. The detail of the verification process will be described later. Note that the reason why the AV data is written on the replace area before the verification process is to enable the AV data to be restored even if it is destroyed by writing and reading operations in the verification process.

In reproducing, there may be a case where read time becomes longer accidentally due to vibrations or the like. If replacing process is performed for all areas where errors occurred even in such a case, there arise a problem that the free space of the replace area is consumed soon. In view of this problem, in the present embodiment, it is verified whether they are defective areas, and the replacing process is performed only for the areas which are really defective.

Then, the microprocessor 9 determines whether the replacing process is completed for all areas registered in the error registration list 35 (S36).

If there remains a record area for which the replacing process is not completed, the microprocessor 9 proceeds to the next entry in the error registration list 35 and performs the aforementioned process for the next area (S32 to S35).

When the replacing process is performed for all record areas registered in the error registration list, or if there is no sufficient free space on the replace area of the hard disk 11, the microprocessor 9 deletes the entries in which the aforementioned process (S32 to S35) is performed from the error registration list 35 (S38), and ends the replacing process.

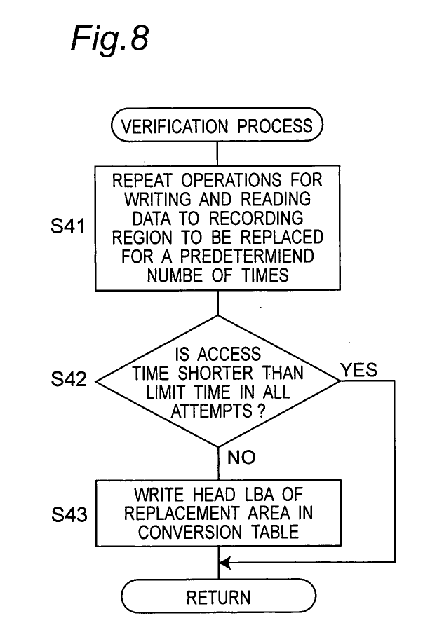

Next, the verification process (S35) will be explained by using FIG. 8.

Reading and writing processes for AV data recorded in the area indicated by the DAU (e.g., the 27th DAU) registered in the error registration list 35 are repeated for a certain number of times (e.g., 30 times) (S41). In order to eliminate an accidental coincidence, a certain number is preferably plural.

After repeating the reading and writing processes for a certain number of times, it is determined whether the read time or the write time did not exceed a predetermined time in all attempts (S42). If the read time or the write time exceeds a predetermined time in at least one attempt, the microprocessor 9 determines that the area is really defective and it should be replaced.

When the microprocessor 9 determines that the area should be replaced, the microprocessor 9 changes the head LBA corresponding to DAU indicating the area to a value of the replace area in the conversion table 33 (S43). FIG. 5A shows the conversion table 33 before the replacing process, and FIG. 5B shows the conversion table 33 after the replacing process. In FIGS. 5A and 5B, the replacing process is performed to the area of the 5th DAU, and the value of the head LBA thereof is rewritten to the value of the LBA of the replace area. Since then, when the data area is specified by referring to the conversion table 33 shown in FIG. 5B, the replaced area is designated.

2.2 Operation During Data Reproducing Operation

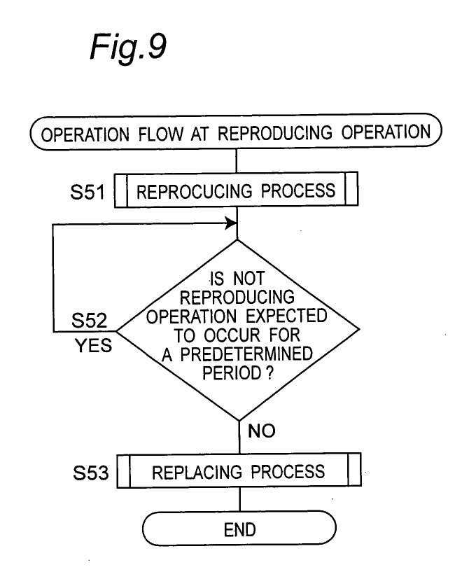

Operation during data reproducing operation of the information recording apparatus of the present embodiment will be explained by using FIG. 9.

The information recording apparatus 1 reads out data in sequence from the hard disk device 4 and performs predetermined processing, and then outputs it to an external device via the IEEE1394 interface 2 (S51). At this time, the microprocessor 9 measures a data read time, and if the read time exceeds the predetermined limit time, registers information about the area from which data is read to the error registration list 35. Then, after the reproducing process (S51), when it is expected that recording or reproducing operation will not be performed within a certain period of time (No in S52), an replacing process is executed (S53). Since the replacing process has been already explained, the reproducing process (S51) will be explained in detail below.

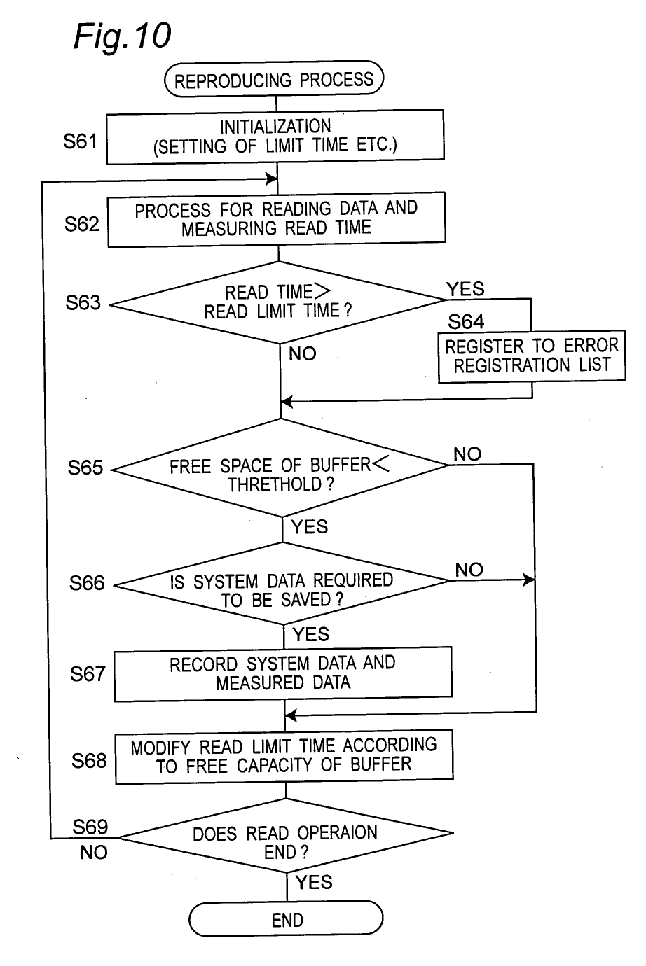

The reproducing process (step S51) will be explained by using FIG. 10.

First, initial setting including setting of a variable required in the following reproducing process is performed (S61). In this step, a limit time (e.g., 150 ms) with respect to the reading process is set.

Next, the signal processor 7 reads out AV data by one DAU recorded on the hard disk 11 of the hard disk device 4, and at the same time, measures a time required for the reading (S62). That is, the microprocessor 9 measures a time from the time of issuing a read command to the time of receiving from the hard disk device 4 a response indicating the completion of the reading as a “read time”, by using the internal timer 9a.

The microprocessor 9 compares the measured read time with the read limit time (S63). If the measured read time exceeds the read limit time, the microprocessor 9 registers the record area from which the reading is performed in the error registration list 35 (S64).

Then, the microprocessor 9 determines whether the free space size of the buffer memory 8 is less than the predetermined threshold (S65). Here, the AV data read out of the hard disk 11 is stored temporarily on the buffer memory 8, and then is output to the outside via the IEEE interface 2.

If the free space size of the buffer memory 8 is less than the threshold, the microprocessor 9 determines whether the system data is required to be saved (S66). If required, the microprocessor 9 records the system data on the hard disk device 4 (S67). At that time, the free space size of the buffer is also saved on the hard disk device 4.

If the free space size of the buffer memory 8 is small, a buffer underrun will not be caused even if the data is not read from the hard disk device 4. Thus the real-time property is not inhibited even though the system data is written on the hard disk device 4 without reading the data from the hard disk 11. As described above, an operation of saving data, which does not require real-time property such as system data, on the hard disk device 4 can be performed by selecting a timing that data is stored sufficiently on the buffer memory. Therefore, it is possible to keep the real-time property when reading AV data from the hard disk device 4.

In contrast, if the free space size of the buffer memory 8 is not less than the threshold, an operation of reading AV data from the hard disk device 4 is given priority so as not to cause a buffer underrun, so the system data is not saved.

Next, the microprocessor 9 changes the read limit time in accordance with the free space size of the buffer memory 8 (S68). For example, if the free space size of the buffer memory 8 is small, the read limit time is set to be longer. In reproducing operation, if the free space size of the buffer memory 8 is small, the buffer memory 8 will not be empty even though it takes time to read from the hard disk 11, and thus there is no problem in extending the read limit time.

Then, the microprocessor 9 determines whether reading of all AV data to be read is completed (S69). If it is determined that reading of all data is completed or if an instruction to stop reproduction of the AV data is received, the signal processor 7 ends reading of the AV data from the hard disk device 4.

Note that the hard disk device 4 may originally have a function of performing an replacing process or a retry process for defective areas, independent from the control by the stream controller 3. If these functions of the hard disk device 4 and the replacing process by the stream controller 3 coexist simultaneously, the efficiency of the processes is expected to be lowered. In such a case, it is preferable that the microprocessor 9 turns off replacing process or retry process originally held by the hard disk device 4 prior to the recording/reproducing operation.

### Second Embodiment

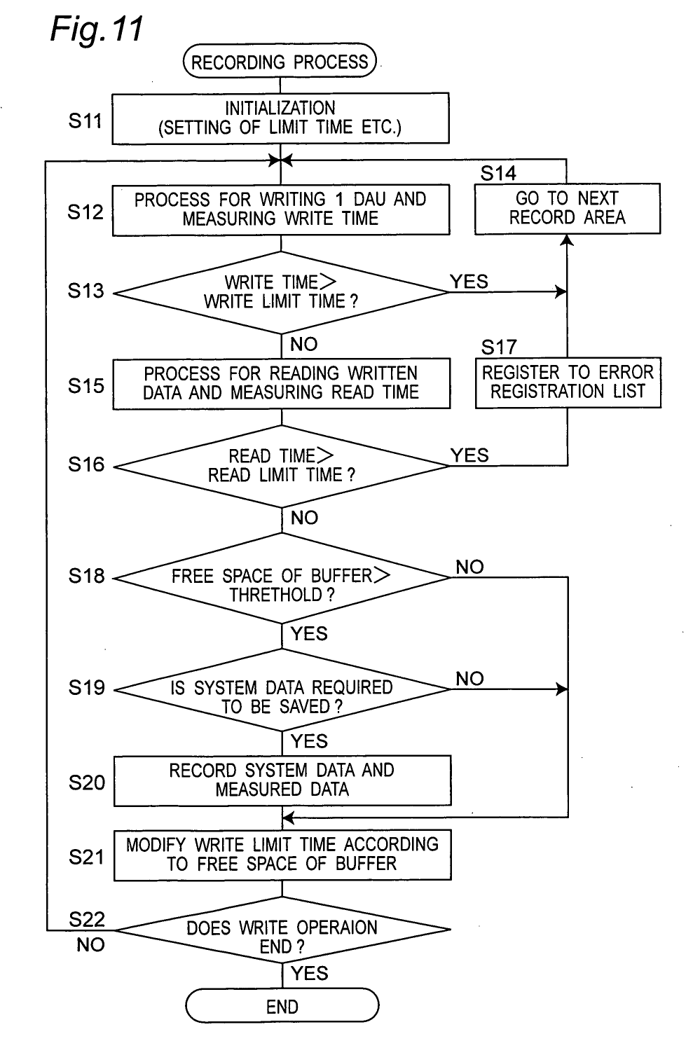

In the present embodiment, another example of the recording process (step S1) will be explained. FIG. 11 shows a flowchart of the process.

In the recording process of the first embodiment (see FIG. 4), if a measured read time exceeds a read limit time as a result of comparing the measured read time with the read limit time (S16), registration to the error registration list 35 is performed and writing to the area is completed.

On the other hand, in the recording process of the present embodiment shown in FIG. 11, if a measured read time exceeds a read limit time, registration to the error registration list 35 is performed, and then the processing moves to the next area (DAU) (S14) and the same AV data is written on that area (S12). That is, if a measured read time exceeds a read limit time, writing onto the area (the nth DAU) is given up and the area is skipped, then the data is rewritten on the next area (the (n+l)th DAU). At this time, the positional information of the skip destination is stored in the system data.

In the process shown in the first embodiment, when a reproducing operation is performed after a recording operation is completed but before an replacing process is performed, there may be a case where a continuous reproducing operation cannot be ensured since replacing process has not been performed yet and data is read from a defective area at the time of reproducing. In contrast, in the process shown in the present embodiment, even in a case where a reproducing operation is performed after a recording operation is completed but before an replacing process, it is possible to read within a range of a normal read time.

Note that although a hard disk is exemplary used as a recording medium in the above-described embodiments, it is obvious that the concept of the present invention is applicable to various recording media such as optical disks and magneto-optical disks.

Although the present invention has been explained for specific embodiments, it is obvious for those skilled in the art that various deformations, modifications and other usages can be made. Therefore, the present invention is not limited to the disclosure specified herein, but can be only limited by the scope of appended claims.

The present application is related to Japanese Patent Application No. 2003-023771 (filed on Jan. 31, 2003), the contents of which are incorporated herein by reference.

### INDUSTRIAL APPLICABILITY

The present invention is a device for recording and reproducing data on/from a recording medium, and is useful, in particular, for an information recording apparatus requiring real-time property in reproducing operation.

1. An information recording apparatus capable of recording input data and reproducing recorded information, comprising:
an input unit that inputs data for record and retention from external;
a recording medium that recording the input data; and
a controller that controls recording and reproducing of data to/from the recording medium, wherein
during an operation for recording the input data on the recording medium by a predetermined amount of data, each time writing of the predetermined amount of data is completed, the controller reads data out from an area of the recording medium in which the data is written just before, and measures a time required for the reading, and compares the measured time for the reading with a predetermined limit time, and determines the area on the recording medium from which the reading is performed to be a defective area if the measured time exceeds the limit time.

2. An information recording apparatus capable of recording input data and reproducing recorded information, comprising:
an input unit that inputs data from outside;
a recording medium that recording the input data; and
a controller that controls recording and reproducing of data to/from the recording medium, wherein
during a recording operation for recording the input data on the recording medium by a predetermined amount of data, each time writing of the predetermined amount of data is completed, the controller reads data out from an area of the recording medium in which the data is written just before, and measures a time required for the reading, and compares the measured time for the reading with a predetermined limit time, determines that the area on the recording medium from which the reading is performed to be a defective area if the measured time exceeds the limit time, and subsequently performs an replacing process to replace the area determined to be a defective area with another normal area on the recording medium.

3. The information recording apparatus according to claim 2, wherein the controller verifies whether the area determined to be a defective area is really a defective area by performing reading and writing operations of data to the area for a predetermined number of times, and based on a verification result, determines whether the area determined to be a defective area should be replaced with another normal area on the recording medium.

4. The information recording apparatus according to claim 2, further comprising error list information that registers the area determined to be a defective area, wherein
the controller performs the replacing process for a plurality of areas registered in the error list information in descending order of measured read time.

5. The information recording according to claim 2, further comprising a buffer memory that stores data temporarily when recording the data onto the recording medium or reproducing the data from the recording medium, wherein
the controller changes the limit time based on the free space size of the buffer memory.

6. An area management method for a recording medium for recording and reproducing data, which replaces a defective area with another normal area, comprising the steps of:
while reading data for record and retention from the recording medium, measuring a time required for the reading;
comparing the measured reading time with a predetermined limit time; and
determining an area on the recording medium from which the reading is performed to be a defective area if the measured time exceeds the limit time.

7. An area management method for a recording medium, for recording and reproducing data, which replaces a defective area with another normal area, comprising the steps of:
while reading data from the recording medium, measuring a time required for the reading;
comparing the measured reading time with a predetermined limit time; and
determining an area on the recording medium from which the reading is performed to be a defective area if the measured time exceeds the limit time, and subsequently replacing the area determined to be the defective area with another normal area on the recording medium.

8. The area management method for the recording medium according to claim 7, wherein the replacing step further comprising verifying whether the area determined to be a defective area is really a defective area by performing reading and writing operations to data from the area determined to be a defective area for a predetermined number of times, and based on the verification result, determining whether the area determined to be a defective area should be replaced with another normal area on the recording medium.

9. The area management method for the recording medium according to claim 7, further comprising the step of storing information about the area determined to be a defective area on a predetermined storing unit, wherein
the replacing step comprises performing an replacing process for a plurality of areas indicated in the information stored on the storing unit in descending order of measured read time.

10. The area management method for the recording medium according to claim 7, further comprising the step of, when data is stored on a buffer memory temporarily during data recording to the recording medium or data reproducing from the recording medium, changing the limit time based on the free space size of the buffer memory.

11. An information recording method for recording input data on a recording medium, comprising the steps of:
writing input data on the recording medium by a predetermined amount of data;
each time the writing of the predetermined amount of data is completed, reading the data from an area on the recording medium to which the data is written just before, and measuring a time required for the reading;
comparing the measured reading time with a predetermined limit time; and when the measured reading time exceeds the limit time, determining the area on the recording medium from which the reading is performed to be a defective area, and subsequently replacing
the area determined to be a defective area with another normal area.
